(19) United States
(12) Patent Application Publication
(10) Pub. No.: US 2009/0276635 A1
(43) Pub. Date: Nov. 5, 2009

(54) CONTROLLING DISTRIBUTION AND USE OF DIGITAL WORKS

(75) Inventors: Constant Paul Marie Jozef Baggen, Eindhoven (NL); Jaap Andre Haitsma, Eindhoven (NL); Antonius Adriaan Maria Staring, Eindhoven (NL); Johan Cornelis Talstra, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/721,060

(22) PCT Filed: Dec. 7, 2005
(86) PCT No.: PCT/IB05/54093

§ 371 Date: Jun. 7, 2007

(30) Foreign Application Priority Data
Dec. 13, 2004 (EP) 04106504.6

(51) Int. Cl. G06F 21/24; G06F 21/00

(52) U.S. Cl. 713/182; 726/27

(57) ABSTRACT

In order to efficiently prevent the save-and-restore attack on usage rights associated with digital work, these usage rights are protected by a hidden channel. In order to make it a difficult or expensive to manipulate the hidden channel, a device is proposed comprising: writing means (34) for writing on a record carrier (20) said digital work (DW) and attached usage right information (22) defining one or more conditions to be satisfied in order for the usage right to be exercised,—fingerprint extraction means (23) for deriving fingerprint data (24) from physically uncontrollable, changeable non-uniformities on said record carrier (20), and authentication means (25) for generating authentication data (26) from said fingerprint data (24) and said usage right information (22), said authentication data being provided for authenticating said usage right information, said writing means (34) being adapted for writing said authentication data (25) on said record carrier (20).

The present invention relates to a method and a corresponding device for controlling distribution and use of a digital work. Further, the present invention relates to a record carrier for storing a digital work, a digital work being understood as any content, such as music, video, software or data, stored and distributed in digital form.

With the advent of new on-line content distribution channels like iTunes, MusicMatch, PressPlay, Windows-Media Digital Rights Management (DRM) has started to play an increasingly important role. Currently three categories of DRM are employed They can be distinguished by the way they store and protect the usage rights (such as “copy one time”, “view until Wednesday”, etc.):
1. Network-centric: the rights are stored securely on a dedicated server in a network. Devices wanting to access content consult the server to obtain (and if necessary update) the rights. The server might reside somewhere on the Internet (e.g. at the content owner's), or in a home network. This DRM category requires devices to be (almost) always on-line when accessing content.
2. (Personal) Card-centric: the rights are stored securely on a removable card or token, e.g. a smart-card, SD card, MemoryStick etc. Devices wanting to access content contact the removable security card to obtain (and if necessary update) the rights. This DRM category requires devices to have a slot for a plug-in card
3. Device-centric: the rights are stored securely inside a fixed playback or storage device (e.g. a PC on which the content resides). A device wanting to access content administers the rights itself. The consequence of this DRM category is that content is always locked to a single device. The MusicMatch—and the original Windows DRM service are examples of such systems.

In the last few years a fourth variant has been developed which aims essentially at marrying the current optical media content distribution business-model to DRM, giving an optical disc almost the same functionality as flash memory cards such as SD-card or MemoryStick:
4. Media-centric: the rights are stored securely on the recordable media itself. Devices wanting to access content have special circuitry to retrieve (and if necessary update) the rights on the media. The consequence of this DRM category is that content can be consumed in any (media-centric DRM compatible) device (rights travel together with the content).

Although the last category looks very appealing from a consumer point of view, technically it is the most complicated one, because the layout of optical media has been standardized giving attackers direct access to all bits and bytes without further need for authentication and knowledge of system secrets etc. Of course, it is well known, e.g. from disc-based copy protection systems (DVD, CD, etc.), how to prevent such bits from being copied, using tools from cryptography (ciphers, key-distribution schemes, broadcast-encryption etc.) and disc-marks/ROM side-channels (wobbles, BCA with unique media ID, . . .). However none of these systems had to contend with the particularly vicious save-and-restore attack, unique to DRM systems with consumable rights.

Contrary to static rights (copy never, copy free, EPN (encryption plus non-assertion state)), consumable rights are rights which typically get more restrictive every time the content is consumed, e.g. play 4×, or record 3×. The save-and-restore attack goes as follows:
content with corresponding digital rights is purchased and legitimately downloaded onto the storage medium;
the attacker makes a temporary bit-copy of the storage medium (“image”) onto some other storage medium, such as a hard-disc drive (HDD);
the original storage medium is “consumed”, i.e. used normally, which means that the rights decrement in some sense;
at any given moment the attacker can restore the original rights by copying back the image from the alternate storage (HDD). In this process the original rights are restored as well, even if the attacker doesn't know what the (encrypted) bits which have been copied back mean: the medium has simply been returned to its virgin state. This is independent of the use of any ROM side-channels such as the “Disc Mark” (e.g. a unique, but fixed media identifier in the BCA).

A method to resolve this hack is disclosed in WO02/015184 A1. According to this method a hidden channel (HC) as a side-channel is introduced. A side-channel is a method to store additional information on a recording medium by exploiting the fact that multiple read-out signals represent the same user-data pattern (data available to the user). E.g. an additional message may be coded in the error-correction parities. The error-correction mechanism will remove these parities, so the user does not see any difference, but dedicated circuitry preceding the error-correction mechanism does. Of course in this example the information capacity of the medium has been increased at the expense of decreasing the system's error-correcting capacity.

According to WO02/015184 A1 the HC is a side-channel on the storage medium containing information which observes the constraint that it cannot be written by the user but only by some compliant DRM application, and is therefore lost in bit-copies. Simple examples are data stored in sector headers and certain parts of the lead-in area. More sophisticated examples are redundancies in the standard for the storage medium, in which information is stored by making a particular choice for such a redundancy, e.g. selecting certain merging bit patterns on CD, or specific trends in the DSV (digital sum value, the running sum of channel-bits) on a DVD as, for instance, described in U.S. Pat. No. 5,828,754, or intentional errors in sector data (which can be corrected by the redundant ECC-symbols). Yet another example is information stored in slow variations of the channel-bit clock as, for instance, described in U.S. Pat. No. 5,737,286.

During the update of rights, the HC is used as follows:
1. when the digital rights are updated (created or overwritten), a new random data-string is chosen and recorded into the HC;
2. the new values of the digital rights are cryptographically bound to (amongst other things) the data-string written into the HC. An example would be constructing a key which depends on the HC-payload, and applying a digital signature to the digital rights with this key; or alternatively to encrypt the digital rights with this key.

In step 2, the signature could be either based on symmetric key cryptography (a so-called Message Authentication Code, or MAC), or public key cryptography (e.g. DSA-, or RSA-based signatures).

During read-out of the rights the following check is performed using the HC:
(i) when the digital rights are read, the data-string is retrieved from the HC;
(ii) the key from step 2 above which depends on the HC data-string is re-created and used to verify the cryptographic relationship between the digital rights and the HC (either check the signature on the digital-rights, or decrypt the digital rights).

Step (ii) prevents the save-and-restore attack: the image, including the original digital rights may be restored by the attacker, but the HC cannot, therefore the check in step (ii) fails. Rights and content keys can be protected in a Key Locker which in turn is protected by a Key Locker Key, which depends (partially) on the payload of a HC. Further, it is not necessary for the data in the HC to be confidential; however, it should be very difficult for the attacker to modify these bits.

However, the system known from WO 02/015184 suffers from a disadvantage: because this known system relies on a universal secret present in every consumer device, viz. the algorithm by which bits are stored in the hidden channel. An attacker could therefore build a non-compliant device which would enable him to get access to the hidden information so that he could manipulate the hidden information, and thus could provide him with illegal access to encrypted content by manipulating any digital rights. It is therefore desired to provide measures which make it very difficult, expensive or even impossible to construct such a device for reasons which do not depend on the presence of a universal secret.

EP 0644474 discloses a method for utilizing medium non-uniformities to minimize unauthorized duplication of digital information. A key depending on fixed media—non-uniformities realized in the media-manufacturing process is used for encryption of “information”. This is done to provide copy-protection, i.e. to prevent copying of the information to another medium). The non-uniformities used in this method can thus be seen as a permanent disc-mark, rather than a dynamic hidden channel, the payload of which can be changed after manufacture.

It is an object of the present invention to provide a method, a corresponding device and a record carrier, by which the above described save-and-restore attack or the circumvention of usage rights by such an attack, respectively, can be prevented efficiently. Non-compliant devices being able to write or manipulate the hidden channel should be very difficult or expensive to construct for technical or physical reasons.

The object is achieved according to the present invention by a device as claimed in claim 1 comprising:
writing means for writing on a record carrier said digital work and attached usage right information defining one or more conditions to be satisfied in order for the usage right to be exercised,
updating means for updating said attached usage right information with a use of said digital work,
authentication means for generating authentication data from said fingerprint data and said usage right information, said authentication data being provided for authenticating said usage right information,
said writing means being adapted for writing said authentication data on said record carrier.

A corresponding method is defined in claim 14. A record carrier for use in a system according to the present invention is defined in claim 15. Preferred embodiments of the invention are defined in the dependent claims.

The invention is based on the idea that the payload of the Hidden Channel is not produced by some random number generator and written to the media by some dedicated circuitry, but rather that the bits of this payload are extracted from a fingerprint produced by some uncontrollable random process which is inherent to the writing process. When digital rights, i.e. the usage right information, are updated, in particular if they are created or overwritten, a physically random process generates a physical fingerprint on the medium. Said fingerprint, preferably a fixed number of bits, i.e. the HC data-string, which are extracted from the fingerprint, are then used in combination with the usage right information to generate authentication data for authenticating the usage right information, preferably during read-out. The authentication data are therefore also recorded on the medium.

During read-out of the usage right information, the fingerprint is again extracted from the medium in the same way in which it has been generated (extracted) during update of the digital rights. Preferably, said fixed number of bits, i.e. the HC data-string, is extracted from the fingerprint. Further, the authentication data are read from the medium and used in combination with the read fingerprint or the information extracted from the fingerprint, respectively, to authenticate the usage right information. This prevents the save-and-restore attack since the image of the original user data stored on the medium, including the original usage right information, may be restored by an attacker, but the HC, ie. the fingerprint cannot, since the fingerprint is obtained from physically uncontrollable non-uniformities on the record carrier which are not reproducible and cannot be copied to another record carrier. The step of authentication, in which said fingerprint is used, will thus fail in case an attacker used the above described save-and-restore attack

According to preferred embodiments the fingerprint data are either extracted from said usage right information on said record carrier, in particular from marks representing said usage right information on an optical record carrier, or from data recorded in the same area as said usage right information on said record carrier, in particular from marks recorded close to said usage right information on an optical record carrier, i.e. from marks substantially co-located with said usage right information.

In the first alternative, when the usage right is updated or when an attacker illegally restores a previous version of the usage right, the fingerprint also changes automatically. In the second alternative there are two advantages: (i) the usage rights may be too short to extract a (reliable or secure) fingerprint from, so that it needs to be extracted from another, longer amount of data, and (ii) if this other amount of data is located not too far away from the usage rights the drive doesn't need to jump (which is time-consuming).

According to a further preferred embodiment the new values of the digital rights are cryptographically bound to (amongst other things) the fingerprint data. An example would be constructing a key which depends on this string, and applying a digital signature to the digital rights with this key; or alternatively to encrypt the digital rights with this key. During read-out the key which depends on the fingerprint data is then re-created and used to verify the cryptographic relationship with between the digital rights and the fingerprint data, e.g. by either checking the signature on the digital rights or by decrypting the digital rights.

There are different possibilities proposed according to the present invention for deriving the fingerprint data. Preferred possibilities are:
from channel-bit errors of predetermined data recorded on said record carrier;
from the positions of the zero-crossings of a read-out signal with respect to channel bit boundaries of predetermined data recorded on said record carrier, i.e. from jitter; or
from the highest or lowest values, respectively, at a predetermined position of predetermined data recorded on said record carrier.

All these possibilities exploit the fact that there are media non-uniformities. In particular, the composition of the storage material of the record carrier should be exactly the same everywhere on the medium so that, when the laser is turned on with a certain power in two different places, exactly the same 1 or 0 is written. In reality this is, however, not true: the media is non-uniform, e.g:
the proportion of elements in the alloy varies a little bit,
small polluting particles may be present, and
the recording layer may vary in thickness, and therefore heat-conduction changes and crystallization properties change along.

This happens both at a large scale, but also at a very local (bit-size) scale. The non-uniformity exploited according to the present invention is the latter. Media non-uniformities are but one source of physical randomness: it is their interaction with other naturally occurring physical processes that yields the randomness, such as bit-errors or jitter, that is used according to the present invention.

When jitter is used as non-uniformities, it is further advantageous that the effect of inter-symbol interference is subtracted before deriving said fingerprint data from the positions of the zero-crossings of a read-out signal with respect to channel bit boundaries of predetermined data recorded on said record carrier. In this way jitter resulting from inter-symbol interference is subtracted and the desired, random jitter caused by physically random processes remains.

In order to increase the accuracy and robustness of the fingerprint extraction during read-out for verification, it is proposed in a further embodiment to additionally generate, during the first read-out of said fingerprint data, error correction or helper data, which are stored on the record carrier. Said error correction or helper data are preferably used in subsequent read-out of the fingerprint data to reconstruct said fingerprint data. Further, they can be used during subsequent read-out for verifying if the fingerprint data retrieved during said subsequent read-out is substantially the same as the fingerprint data recorded during the first read-out.

The present invention will now be explained in more detail with reference to the drawings in which

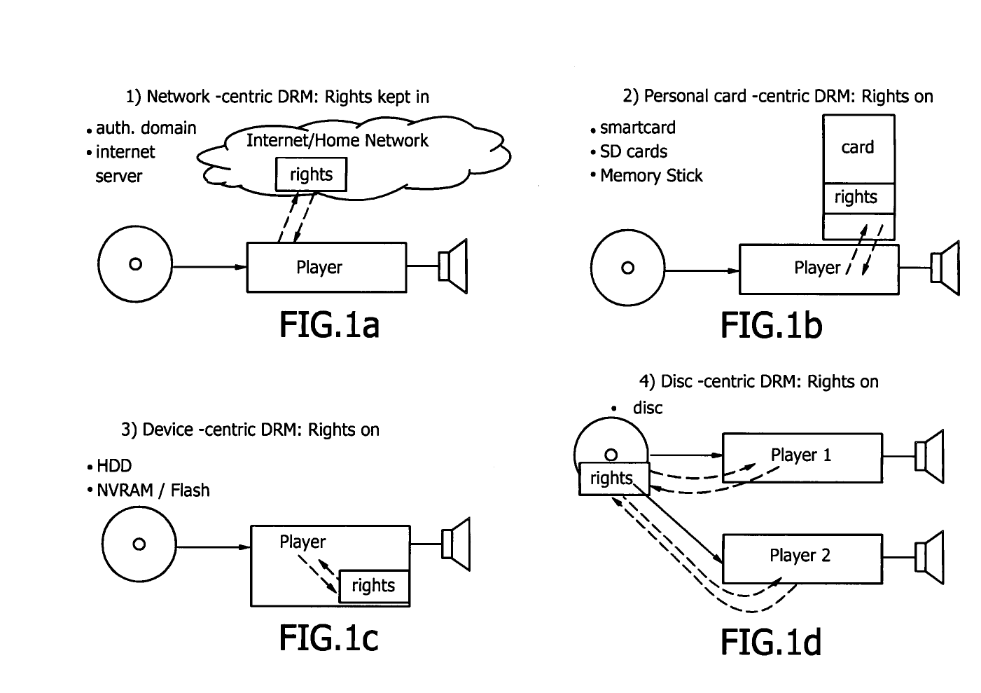

FIG. 1 shows four different categories of a digital rights management system,

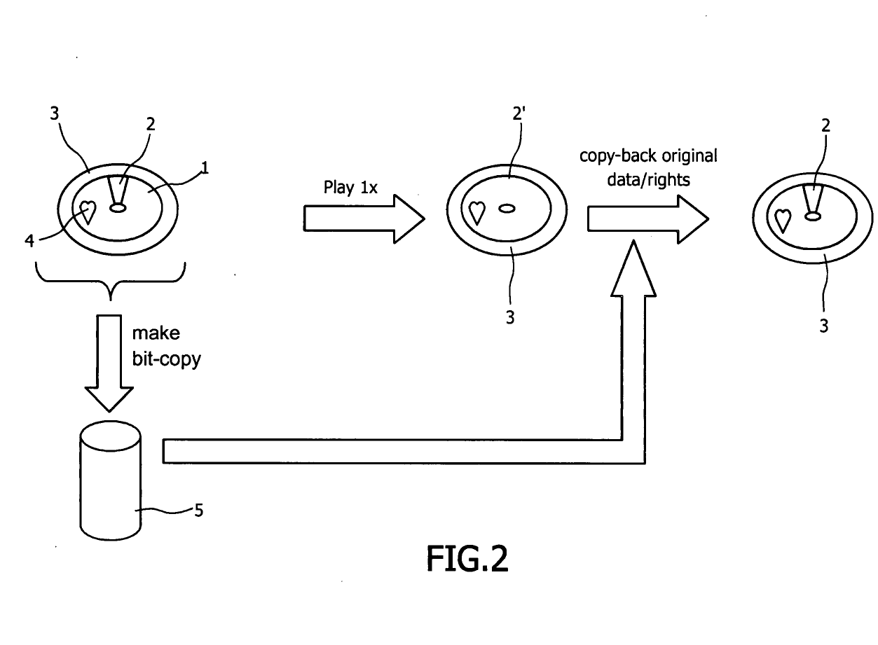

FIG. 2 illustrates the save-and-restore attack,

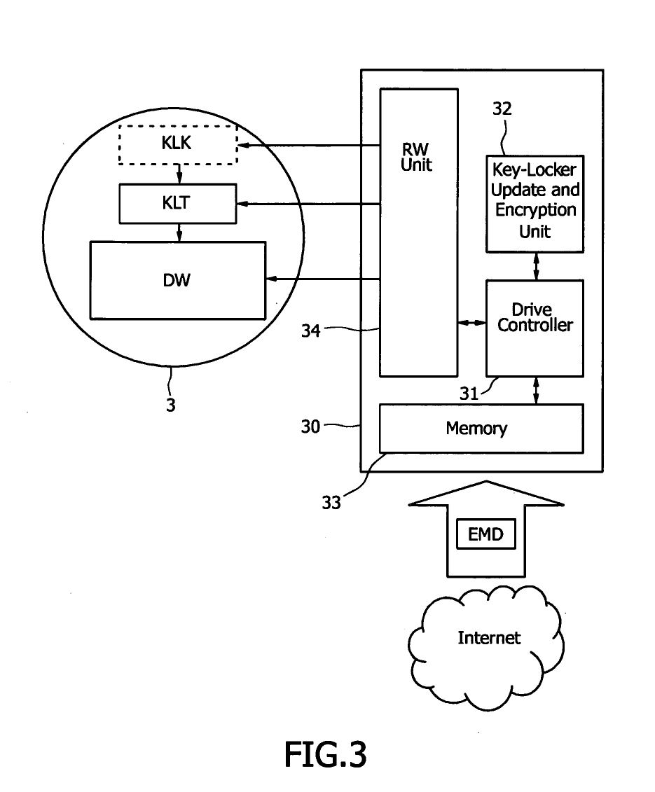

FIG. 3 illustrates an known architecture of a DRM system,

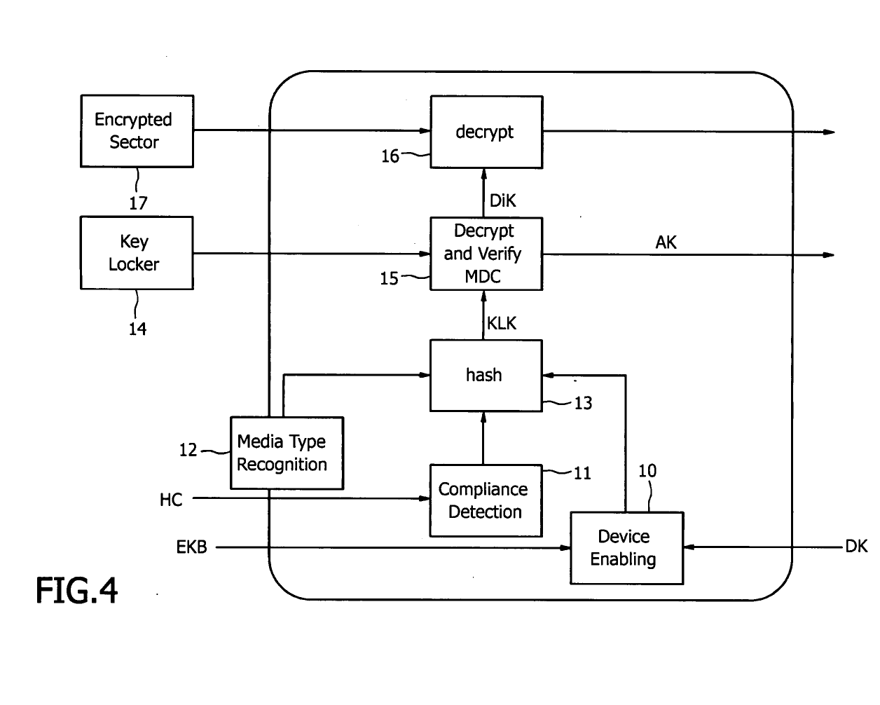

FIG. 4 illustrates the known architecture of a DRM system in more detail,

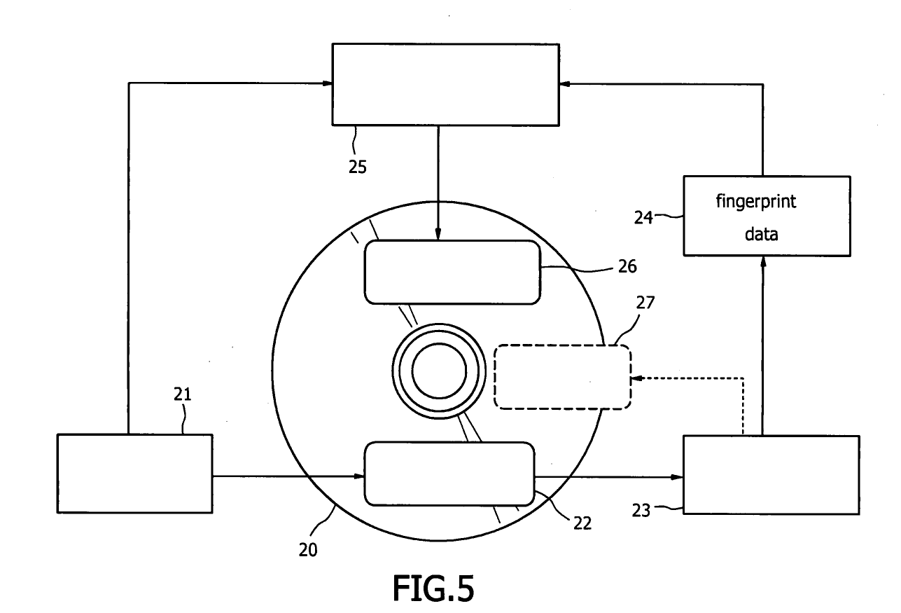

FIG. 5 illustrates the method according to the present invention for updating digital rights,

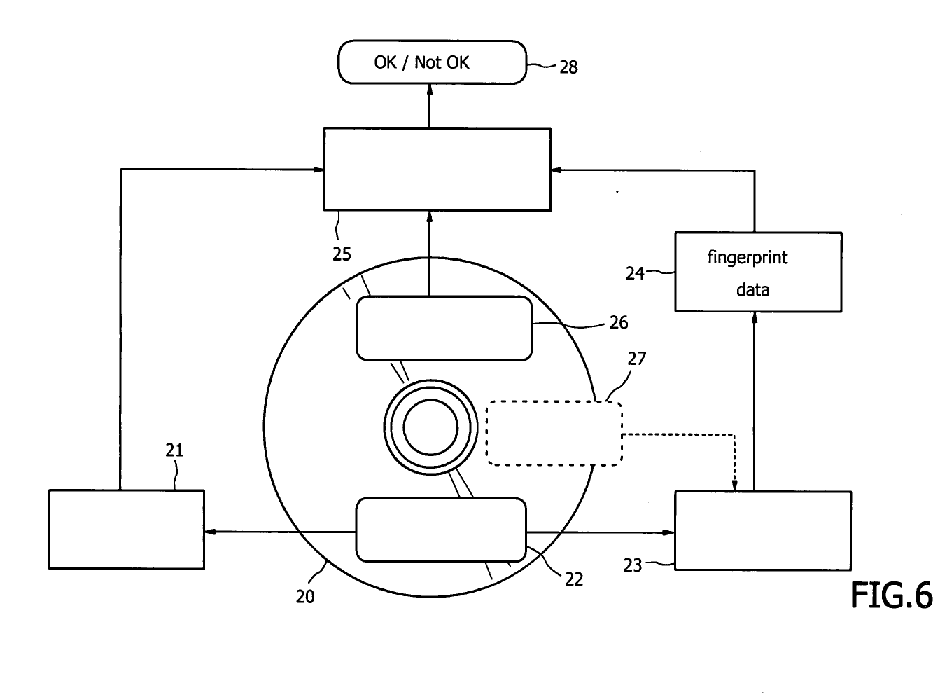

FIG. 6 illustrates the method according to the present invention for verification of digital rights,

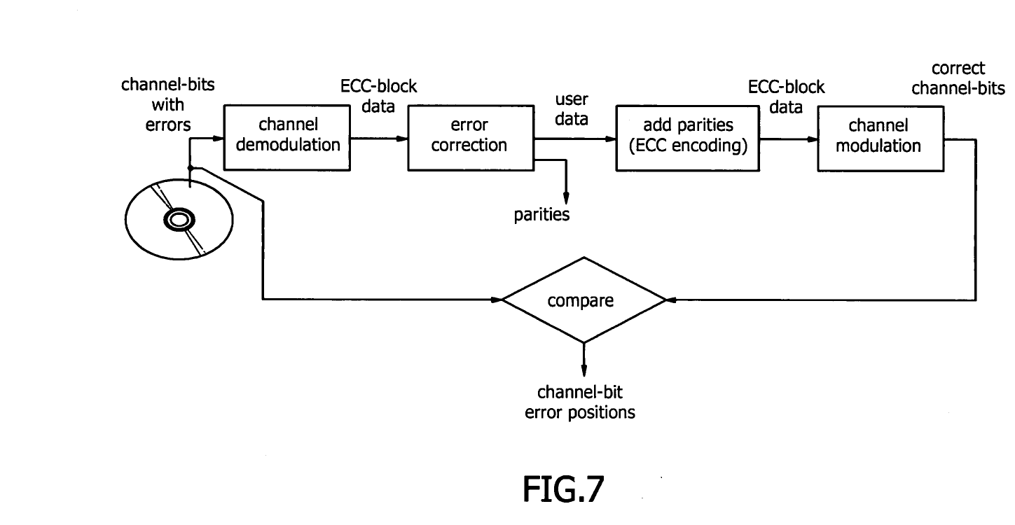

FIG. 7 shows an embodiment for creating channel-bit error positions as non-uniformities and

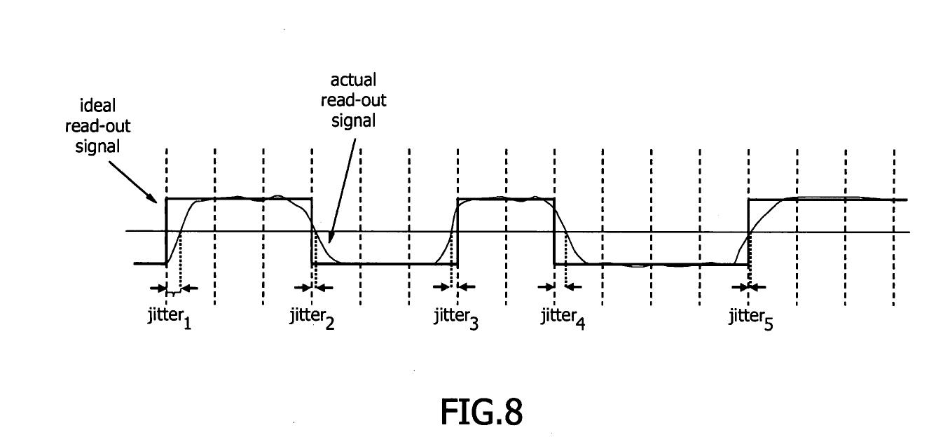

FIG. 8 illustrates an embodiment for using jitter as non-uniformities.

FIG. 1 illustrates the above described four different categories of digital rights management (DRM): FIG. 1a illustrates a network based DRM in which the digital rights are stored on a dedicated server in a (home) network or the internet. FIG. 1b illustrates a personal-card based DRM in which the digital rights reside in a secure plug-in card, such as a smartcard, an flash-card or other memory card. FIG. 1c illustrates a device-centric DRM in which the digital rights are protected by storing them securely in a playback/storage device, such as a hard disk, an NVRAM or an embedded flash memory. FIG. 1d illustrates a media-centric DRM in which the digital rights are protected by storing them securely on the storage medium, such as an optical disc.

However, the preferred system shown in FIG. 1d does not provide sufficient security against the save-and-restore attack which is schematically illustrated in FIG. 2 for the case of a “play-1×” right. According to this attack in a first step content 1, e.g. encrypted music, is purchased and downloaded through E-commerce together with digital rights 2 (here “play-1×” as an example). Both the content 1 and the digital rights 2 are stored on a (rewritable) record carrier 3, e.g. a DVD+RW or CD-RW disk, said record carrier 3 preferably also carrying a carrier mark 4, e.g. a unique serial number.

In the next step the attacker makes a temporary bit-copy (an “image”) of the record carrier 3, including the content 1 and the digital rights 2, onto another storage medium 5, e.g. a hard disk. The original digital rights are then “consumed”, i.e. used normally, so that the rights 2 are “decremented” on the record carrier. Here in this example the “play-1×” right is decremented into the right 2′ “play-0×” on the record carrier 3. Thereafter, however, the attacker can restore the original rights 2 by copying the image from the storage medium 5 to the record carrier 3 so that the digital rights (now being again “play-1×”) and the content can be used again.

FIGS. 3 and 4 illustrate a system for protection of the digital rights stored in a key locker with the help of a hidden channel as disclosed in WO02/015184. FIG. 3 shows, in particular, a basic block diagram of a disc drive 30, as it is also used according to the present invention, which is arranged to generate and write a key locker table KLT together with a digital work DW (i. e. a music track or the like) on a recordable disc 3 based on usage right acquired together with a purchase from the Internet. In particular, an EMD (Electronic Music Download) application which may run on a computer system to provide a corresponding download function stores the purchased scrambled digital work DW together with the key required for descrambling the digital work, and a description of the usage rights in a memory 33 of the disc drive 30. As an alternative, the purchased pieces of information may be stored in a memory of the computer system from which they are read by a drive controller 31 of the disc drive 30.

The drive controller 31 reads the purchased pieces of information from the memory 33 and supplies the key and the usage rights to a key locker update and encryption unit 32 which is arranged to generate a corresponding key locker table KLT (also called key locker) and to randomly select a key locker key KLK used for encrypting the key locker table KLT. The drive controller 31 receives the generated key locker table KLT and key locker key KLK and controls a reading and writing (RW) unit 34 so as to write the purchased digital work DW (i. e. music track) and the key locker table KLT at predetermined positions on the recordable disc 3. Furthermore, the drive controller 31 controls the RW unit 34 so as to store the key locker key KLK in a hidden channel of the recordable disc 3, which is not accessible by conventional disc drives or disc players. With every change of the purchased usage right due to a consumption (i. e. copy or play operation), the drive controller 31 supplies a corresponding control signal to the key locker update and encryption unit 32 which updates the key locker table KLT correspondingly, generates a new randomly selected key locker key KLK, and encrypts the key locker table KLT using the new key locker key KLT. The drive controller 31 receives the updated and scrambled key locker table KLT and the new key locker key KLK and controls the RW unit 34 so as to write the re-scrambled key locker table KLT onto the recordable disc 3 and the new key locker key KLK in the hidden channel. This updating and re-encryption by using a new key locker key KLK is thus performed after each change inside the key locker table KLT. If the updated key locker table KLT indicates that the usage rights have been exercised or consumed, the disk controller 31 refuses the use of the respective digital work, e. g. by transmitting a corresponding error message or control signal to the EMD application.

FIG. 4 shows the layout of the disk drive 30 illustrated in FIG. 3 in more detail. By use of device keys DK and an enabling key block EKB a device enabling unit 10 performs device enabling by which revoked devices can be rendered inoperable. Further, a compliance detection unit 11 and a media type recognition unit 12 are provided for compliance detection of the hidden channel HC or media type recognition. The output of units 10, 11 and 12 is provided to a hash unit 13 for generating a key locker key KLK. By use of the key locker key KLK the key locker 14 is decrypted and verified in decryption/verification unit 15 to obtain a disc key DiK and asset keys AK. The disc key DiK is further used in a decryption unit 16 to decrypt encrypted content 17 which can then be outputted for reproduction.

According to this system distribution and use of a digital work stored together with an attached usage right information on a record carrier is provided. The attached usage right information, i.e. the information stored in the key locker, is encrypted or verified by using a hidden information which is changed at every change of said usage right information. The hidden information may be an encryption key used for encrypting the usage right information, or a checksum of a data block containing the usage right information. Thus, a save-and-restore attack can be prevented since it will lead to a mismatch between the hidden information and the restored usage right information.

However, an attacker could build a non-compliant device which would enable him to get access to the hidden information so that he could manipulate the hidden information, and thus could provide him with illegal access to encrypted content by manipulating any digital rights. It is therefore desired to provide measures which make it very difficult, expensive or even impossible to construct such a device for technical or physical reasons.

FIG. 5 is a graphical illustration of the method according to the present invention to generate a physically random HC data-string, i.e. fingerprint data extracted from a fingerprint.

In a first step a physically random process is used to generate a physical fingerprint on the record carrier 20 when the digital rights (i.e. the key locker data) 21 are created for the first time or overwritten later. Such a physically random process can be any dynamic non-uniformities appearing during the writing process of data on the record carrier 20 as will be explained in more detail below. The key locker data 21 are then also to be recorded as written data 22 on the record carrier 20.

In the embodiment shown in FIG. 5 these written data 22 or part thereof is used as the area representing the fingerprint from which thereafter fingerprint data 24 (for instance a fixed number of bits also called the HC data-string), is extracted by a fingerprint extraction unit 23 by some detection algorithm. Said fingerprint data 24 is cryptographically tied to the digital rights 21 stored in the key locker by a cryptographic unit 25 thus generating authentication data 26 which are also recorded on the record carrier 20. Examples of authentication data 26 are, for instance, a (fingerprint dependent) signature of the key locker, the key locker encrypted with a fingerprint, etc.

In order to increase the robustness of fingerprint extraction, optionally some helper data 27, for instance additional error-correction information, can be stored on the record carrier 20. These helper data 27 can then be used during read-out for verification to achieve a robust representation of the fingerprint as will be explained below in more detail.

FIG. 6 is a graphical illustration of the method according to the present invention to check that a physically random-generated HC data-string, i.e. fingerprint data extracted from a fingerprint, observes a predetermined cryptographic relationship with the digital rights, i.e. that those rights have not been restored. When the digital rights 21 are read, the fingerprint data 24 is again extracted from the fingerprint by the same detection algorithm as has been used during update of the digital rights. The cryptographic relationship between the digital rights 21 and the fingerprint data 24 is recreated by the cryptographic unit 25 and used to verify the cryptographic relationship between the digital rights and the fingerprint data, for instance by verification against the authentication data 26 read from the record carrier 20 (e.g. by checking the signature on the digital rights or by decrypting the digital rights). This check provides the result 28 whether the digital rights have been restored or not, i.e. if the save-and-restore attack has been used in which case the original digital rights might have been restored by an attacker, but not the fingerprint and the fingerprint data due to the use of a physically random process for generating the physical fingerprint on the record carrier 20.

In the following examples of physically random processes generating such a fingerprint shall be explained.

In one example, first a batch of arbitrary data (preferably the key locker itself) is written to the medium (e.g. a few ECC-blocks). The fingerprint comprises a pattern of channel-bit errors in this batch. The channel-bit error locations can be determined by reading back the ECC-blocks of the batch, demodulating and error-correcting them, and comparing their ECC- and channel-re-modulated version with the version read directly from the medium. FIG. 7 shows an example for determining such channel bit error positions in case of an optical medium. According to this example the correct channel-bits are determined by usual channel demodulation of the channel-bits read from the optical medium and error correction, and thereafter ECC encoding and channel modulation. The correct channel-bits are then compared to the original channel bits including the errors to obtain the channel-bit error positions.

The bit-string extracted from this fingerprint could be the concatenation of the distances between the positions of the channel-bit errors, or their position with respect to a fixed position on the recording medium (sync-words, sector-start-address etc.). With a high likelihood, every time data is written to the media a new set of write-errors is made, dictated by many things not under control of the user (e.g. quality of the disc, relative position of data with respect to inaccuracies in the recording layer, phase-noise in the write-clock regenerated from a pre-groove wobble etc.).

In a further example, first an amount of arbitrary data (preferably the key locker itself) is written to the medium, e.g. an optical disc. The fingerprint comprises the positions of certain zero-crossings of the read-out signal with respect to the channel bit boundaries. Ideally (i.e. in case of a linear write/read-channel with infinite bandwidth) the HF-signal would be a true square-wave with zero-crossings lying precisely on a grid of uniformly spaced allowed positions determined by the channel-bit clock. Because of the non-linearity and the finite bandwidth of the channel, media non-uniformities, and other phenomena not under the user's control, the zero-crossings deviate from their ideal positions. This is generally referred to as jitter. In this case it is proposed according to an embodiment of the present invention that a particular jitter realization is taken as a fingerprint as illustrated as an example in FIG. 8 where the time-difference (positive or negative) of the zero-crossings with respect to their ideal position is taken as the fingerprint.

Taking jitter as source of physical randomness requires some care because of Inter-Symbol Interference (ISI). It turns out that this phenomenon caused by the finite bandwidth of the read/write-channel, extends the support of one channel bit into its neighboring bits (e.g. a long, dominant, run of, for instance, 11 ‘1’s followed by a short run of 3 ‘0’ tends to shorten the run of ‘0’s and move the zero-crossing to the right). ISI usually dominates the jitter-pattern, which will therefore not change if the same channel-bit pattern is written again, as required by the present invention. To prevent this, in fingerprint detection, the effect of ISI is preferably subtracted, e.g. following the teachings of P. Sutardja in IEEE Trans. Magnetics, Vol. 26, No. 5, 1990, pp 2303-2305.

Ideally the recorded signal is a train of rectangular pulses. Every data bit corresponds to a pulse (0=up, 1=down). Because the pulses don't overlap, the analog signal measured at time t should be determined only by the bit (0 or 1) that was being transmitted at t, and not by its neighbours. However, in reality the optical recording channel is more like a low pass filter. The effect of that is that every pulse starts to spread out (starts to look a bit like a sinc-pulse), and leaks into its neighbours. So the value measured at time t is still dominated by the bit transmitted at time t, but also influenced a little bit by the neighbours. This means that the points where the analog signal crosses 0 will now shift to the left or right. This is called jitter. Jitter is undesired because players generally try to regain a clock signal out of the positions of the zero crossings: i.e. try to choose graph-paper with a pitch (=clock-frequency) which best matches the zero-crossings. Because of jitter this is much harder. Whether the jitter is to the left or right and by how much requires a calculation. The above mentioned article of P. Sutardja gives a practical approximation to such a calculation. Basically a table is made with on the left the two runs being separated by the zero-crossing-on-the-move, and on the right the amount by which the zero-crossing needs to be shifted back to end up on the grid.

This is of interest because the real measured jitter consists of 2 parts: the ISI-jitter described above plus jitter due to physically random processes (media non-uniformities, laser noise, etc.). For the purpose of the present invention, the first part is not evaluated and used because it is deterministic: it is identical, every time the same data are written, i.e. the ISI-jitter is not really random The physically random jitter, however, is never twice the same, but unfortunately it is dominated by the much larger ISI-jitter, so that the latter needs to be subtracted first, before the desired physical randomness is obtained.

In a third example, first an amount of arbitrary data (preferably the key locker) is written to the medium, e.g. an optical disc. The fingerprint then comprises the highest absolute value in the middle of a particular run.

Next, examples of a cryptographic relationship between the fingerprint data (the HC data-string and the key locker) are explained. There are 2 main methods to tie the fingerprint to the digital rights in the key locker:

According to a first method the data from which the fingerprint is extracted is the (updated) key locker itself. The advantages are two-fold: when the key locker is updated, the fingerprint is automatically generated. Secondly, when an attacker attempts to restore an old version of the key locker, automatically a new fingerprint is generated. This is known from WO 2002/95748 A2. In this case the authorization data in FIG. 5 consists of the digital data and some cryptographically secure function f(KL, FP), where KL=key locker, FP=fingerprint, e.g.

Auth_data=Sign(K, KL || FP), K some other key in the system, or
Auth_data=Encrypt(KLK, FP), where KLK is a key also used to encrypt the key locker.

According to the other method the data from which the fingerprint is extracted is (spatially) separated from the (updated) key locker. In this case, the same possibilities are available as in the previous item f(KL,FP) such as Auth_data=Sign(K, KL || FP) or Encrypt(KLK, FP). These are so called decision-based security measures, because during the read-out phase the result of the same calculation is compared to the Auth_data for equality: the security ultimately depends on the proper execution of an “if”-statement.

There are also so-called information-based security measures, in which an attack manifests itself not through a failed “if”-statement, but through the failure of a decryption operation. For instance, if the Auth_data is constructed as follows:

Auth_data=Encrypt(K, KL), where K=Hash(K′ || FP), and K′ some other key in the system, tampering with the fingerprint causes the key locker key K to change, and the decryption step will generate invalid data.

Because the HC/fingerprint according to the present invention is based on a physical source of randomness, the bits extracted from such fingerprint can be unreliable upon read-out, especially on other read-out devices or under different environmental conditions. When the bits of the fingerprint are used directly in a cryptographic operation, e.g. the construction of an encryption- or signature-key, this is problematic, because if but one of these bits toggles, the encrypted or signed message is completely different and would signal tampering where there was none. To prevent this, the following improvements are proposed:

In one improvement, additionally in the step of extracting the fingerprint data (HC data string), extra information is recorded to aid in extraction of the fingerprint, such as additional error-correction symbols, or so called helper data, as for instance disclosed in “On enabling secured application through off-line biometrics identification”, G. Davida et al., IEEE 1998 Symposium on Research in Security and Privacy, April 1998, Oakland, Calif. When extracting the fingerprint during read-out for verification, the ECC-parities or helper-data is used to come to a robust binary representation of the fingerprint.

Depending on the details of the ECC- or helper data-scheme, there is an opportunity for an attack whereby the additionally recorded information is changed by the attacker. The attacker may manipulate the ECC-parities/helper-data to “push” the detected fingerprint to the original fingerprint bits. To prevent this, the recorded bits can be further protected with another key in the system, e.g. by digitally signing them (with a private key or using a MAC-algorithm), or encrypting them.

In a further improvement, additionally in the step of extracting the fingerprint data (HC data string), the extracted fingerprint data themselves are recorded on the same recording medium. When retrieving the fingerprint during read-out, the extracted bits are compared to the recorded bits, and if both patterns are considered sufficiently similar, the key locker with digital rights is deemed to not have been tampered with, and/or is unlocked with a key based on the recorded representation.

The determination whether recorded and extracted fingerprints are sufficiently similar, can be done using different methods. The idea of this determination is that, if a number of bits is extracted from the fingerprint and a fair amount of those are the same as bits which are extracted before, it is probably the same fingerprint. However, it could, of course, really be another fingerprint because somebody wrote to the key locker and created a new fingerprint that just happened to look like the old one. So it depends on the statistics of the naturally occurring fingerprints and the statistics of the read-out noise on the fingerprints how strictly the fingerprint has to be checked (e.g. if the noise if very small, e.g. typically 2 bits flip, one has to be very suspicious if 10 bits have flipped).

Other cryptographic combinations of key locker, HC/fingerprint data, additionally recorded data and system data can be imagined. For instance, in the above described first improvement the originally extracted and recorded fingerprint data could be protected by a signature with another key available to compliant devices.

The present invention can be used in any DRM system and with any kind of record carrier, preferably in optical disc-based DRM systems using a hidden channel for content protection, in particular for Blu-ray Disc systems, more specifically the copy protection system for PC-enabled BD-RE, and for DVD+RW.

The present invention thus provides an improvement of the system known from WO02/015184 A1 describing the protection of digital rights in a key locker through a key locker key in a hidden channel. The present invention proposes to use, in an embodiment, as a key locker key a physically-uncontrollable random process (or fingerprint), such as a pattern of channel-bit errors created during the writing of a block of data. This is a significant improvement over the system known from WO02/015184 because the known system relies on a universal secret present in every consumer device, viz. the algorithm by which bits are stored in the hidden channel. Here, in contrast, the security does not rely on a universal secret, but on the (near) impossibility of reconstructing the outcome of some physically uncontrollable random process.

1. A device for controlling distribution and use of a digital work, comprising:
writing means (34) for writing on a record carrier (20) said digital work (DW) and attached usage right information (21, 22) defining one or more conditions to be satisfied in order for the usage right to be exercised,
fingerprint extraction means (23) for deriving fingerprint data (24) from physically uncontrollable, changeable non-uniformities on said record carrier (20), and
authentication means (25) for generating authentication data (26) from said fingerprint data (24) and said usage right information (21, 22), said authentication data being provided for authenticating said usage right information,
said writing means (34) being adapted for writing said authentication data (25) on said record carrier (20).

2. Device as claimed in claim 1, wherein said fingerprint extraction means (23) are adapted for deriving said fingerprint data (24) from said usage right information (21, 22) on said record carrier (20), in particular from marks representing said usage right information on an optical record carrier.

3. Device as claimed in claim 1, wherein said fingerprint extraction means (23) are adapted for deriving said fingerprint data (24) from data recorded in the same area as said usage right information (21, 22) on said record carrier (20), in particular from marks recorded close to said usage right information on an optical record carrier.

4. Device as claimed in claim 1, wherein said authentication means (25) are adapted for generating said authentication data (26) by cryptographically binding said fingerprint data (24) to said usage right information (21, 22), in particular by use of a signature or by use of encryption.

5. Device as claimed in claim 1, wherein said fingerprint extraction means (23) is adapted for deriving said fingerprint data (24) from channel-bit errors of predetermined data recorded on said record carrier (20).

6. Device as claimed in claim 1, wherein said fingerprint extraction means (23) is adapted for deriving said fingerprint data (24) from the positions of the zero-crossings of a read-out signal with respect to channel bit boundaries of predetermined data recorded on said record carrier (20).

7. Device as claimed in claim 6, wherein said fingerprint extraction means (23) is adapted for subtracting the effect of inter-symbol interference before deriving said fingerprint data (24) from the positions of the zero-crossings of a read-out signal with respect to channel bit boundaries of predetermined data recorded on said record carrier (20).

8. Device as claimed in claim 1, wherein said fingerprint extraction means (23) is adapted for deriving said fingerprint data (24) from the highest or lowest values, respectively, at a predetermined position of predetermined data recorded on said record carrier (20).

9. Device as claimed in claim 1, further comprising helper data generation means (32) for additionally, during the first read-out of said fingerprint data (24), generating error correction or helper data (27), which are stored on the record carrier (20).

10. Device as claimed in claim 9, wherein the error correction or helper data (27) are used in subsequent read-out of the fingerprint data (24) to reconstruct said fingerprint data.

11. Device as claimed in claim 9, wherein said writing means (34) are adapted for writing the error correction or helper data (27), which are retrieved during the first read-out, on the record carrier (20).

12. Device as claimed in claim 11, further comprising verification means (23) for verifying during subsequent read-out of the fingerprint data (24) if the fingerprint data retrieved during said subsequent read-out is substantially the same as the fingerprint data recorded during the first read-out.

13. Device as claimed in claim 1, further comprising:
updating means (32) for updating said attached usage right information with a use of said digital work,
control means (31) for refusing the use of said digital work if said updated usage right information (21, 22) indicates that the usage right has been completely exercised.

14. Method for controlling distribution and use of a digital work, comprising the steps of:
writing on a record carrier (20) said digital work (DW) and attached usage right information (21, 22) defining one or more conditions to be satisfied in order for the usage right to be exercised,
deriving fingerprint data (24) from physically uncontrollable, changeable non-uniformities on said record carrier (20),
generating authentication data (26) from said fingerprint data (24) and said usage right information (21, 22), said authentication data being provided for authenticating said usage right information, and
writing said authentication data (25) on said record carrier (20).

15. Record carrier, in particular for use in a system for controlling distribution and use of a digital work, comprising:
said digital work (DW),
attached usage right information (22) defining one or more conditions to be satisfied in order for the usage right to be exercised,
physically uncontrollable, changeable non-uniformities for deriving fingerprint data (24), and
authentication data (26) generated from said fingerprint data (24) and said usage right information (22), said authentication data being provided for authenticating said usage right information.
